(19) United States
(12) Patent Application Publication
(10) Pub. No.: US 2006/0041923 A1
(43) Pub. Date: Feb. 23, 2006

(54) Hand-held remote personal communicator & controller

(76) Inventor: Arnold McQuaide JR., Berkeley Lake, GA (US)

Correspondence Address: SCOTT P. ZIMMERMAN, PLLC, PO BOX 3822, CARY, NC, 27519, US

(21) Appl. No.: 11/004,305

(22) Filed: Dec. 4, 2004

Related U.S. Application Data
(60) Provisional application No. 60/602,147, filed on Aug. 17, 2004.

(51) Int. Cl. H04N 7/173; H04N 7/16

(52) U.S. Cl. 725/131; 725/100; 725/139; 725/106

(57) ABSTRACT

A personal communications and control system (PCCS) is disclosed. This PCCS includes a set top box communicating streams of signals to a remote control device. The streams of signals include television signals, telephone signals, and control signals, as well as other video, audio, or graphical content. The television signals are displayed on a display of the remote control device, and the telephony signals are audibly presented at the remote control device as a telephone call. The remote control device also sends the control signal to remotely control a device. This remote control device thus has video capabilities, wireless control capabilities, and wireless communications capabilities. The personal communications and control device may remotely select Internet Protocol television, websites, photos, music, videos, and other content from local storage or from remote storage.

### CROSS-REFERENCE TO RELATED APPLICATIONS

This application claims the benefit of U.S. Provisional Application 60/602,147, filed Aug. 17, 2004, and entitled “Internet Protocol Television Service.” This application also relates to the commonly assigned and concurrently filed U.S. applications Ser. No. ______, entitled “Personal Multi-Modal Control and Communications System” (Attorney Docket BS040302) and Ser. No. ______, entitled “Hand Held Remote Personal Communicator and Controller” (Attorney Docket BS040223). These commonly-assigned applications are all incorporated by reference.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND

This application generally relates to computer graphics processing, operator interface processing, selective visual display systems, and to television. This application, more particularly, relates to a remote control for electronic devices. This remote control may have multiple modes of operation, such as a remote mode of operation, a monitor mode of operation, and a telephone mode of operation.

Remotely controlled electronic devices are a part of everyday life. Televisions are almost exclusively commanded using a remote control. Stereos, entertainment systems, and other audio components are also now commanded using a remote control. Because so many electronic devices are remotely controlled, so-called universal remotes are now offered that integrate command functions for several devices into a single remote control.

Digital data and packet protocols now allow for more advances in remote controls. As more and more entertainment content is digitally transmitted using packetizing protocols, remote controls can evolve to receive all types of content, including richer content communicated using the I.E.E.E. 802 (b) and (g) standards. What is needed, then, is a remote control that can receive and distinguish all manner of data.

### SUMMARY

The aforementioned problems, and other problems, are reduced, according to the exemplary embodiments, using a multi-mode remote control device. This remote control device has video capabilities, wireless control capabilities, and wireless communications capabilities. Because the remote control device has multiple modes of operation, the remote control device is a true personal communications and control device. This personal communications and control device provides personal communications and remote control of auxiliary electronic devices. The personal communications and control device, however, may also serve as a remote control device for selection of content from local and remote content sources. Such content could be Internet Protocol television, information obtained from Internet Websites, information and/or content from local storage (e.g., selection of photos or other graphical material or music files saved on a computer hard disk, or selection of video content saved on a personal video recorder), or content retrieved from a remote storage device. Such remotely retrieved content could be monitored on the remote control device prior to selection and display on a central presentation (e.g., entertainment) system. The remote control device has a display screen for text, graphics, video as well as local sound monitoring capabilities. The remote control device has interactive communications capabilities for handling telephone, interactive text chat, video chat, and other forms of communications. The remote control device may also wirelessly communicate with a set top box, connected to one or more networks, for both content access and interactive communications.

This personal communications and control device operates as a remote control. Because the remote control device may wirelessly communicate with a set top box, the set top box provides remote control of a content access system (such as a PC or home entertainment receiver). The content access system may have local storage (e.g., files of photographs, .wav/.mp3/.mp4 music files, word processing files, or stored video). The remote control device permits remote browsing of remote content sources prior to signaling the content access system to select specific content for presentation on central presentation system(s) such as TV screens or audio systems. The remote control device may also direct that communications information be presented on the central presentation, such as presenting caller ID information for incoming calls. This personal communications and control device is useful for remotely controlling home networks, audio/entertainment systems, computers, and any device communicating with a home network.

The remote control device has multiple modes of operation. The remote control device can wirelessly control other devices (e.g., a television), provide wireless communications (e.g., a wireless telephone), access stored content, and display video and pictures on a display. This remote control device thus operates as a remote for electronic devices, as a monitor for viewing video, text, and/or graphical content, and as a telephone for making and receiving telephone calls. This remote control device may send and receive command signals, thus remotely controlling operation of a television, audio component, or other electronic device. The remote control device, however, also receives at least one (1) stream of packetized data. The remote control device, for example, may receive television signals and/or exchange data with Internet websites that the remote accesses. These television signals are displayed on the remote's own display device, thus allowing the remote control device to operate as a monitor by displaying television signals, locally stored content, Internet information, or other similar information prior to its delivery to a central presentation system for display. The remote control device, however, may also send and receive packetized telephone or video signals, thus allowing the remote to operate as a telephone. A user may thus use the remote control device to remotely command a television or other electronic device, to place and to receive telephone calls, to conduct video chat sessions, to access local or remote (via the Internet) content, and to present or display the same or a different channel from that shown on the television.

The remote control device may include means for switching modes of operation. The remote control device may operate in any of multiple modes. These modes include, for example, a remote controlling operation of an electronic device (such as a television, audio component, computer, or appliance), a monitor displaying visual content, a wireless/cordless telephone placing and receiving telephone calls, and/or as a hand-held video chat device. The remote control device, then, includes means for switching between these modes of operation. The means for switching modes of operation may additionally or alternatively utilize packet headers. That is, when a packet is received, the remote control device inspects the header to determine how the packet is processed. If the header identifies the packet as containing audio and/or video content, the packet is visually/audibly presented. If the header identifies the packet as containing telephony signals, the packet is processed as a telephone call. The remote control device may also packetize telephone calls and/or command signals with a header portion. The header portion identifies how the packet should be processed by the receiving device.

According to the exemplary embodiments, Internet Protocol web content, television signals, and Internet Protocol telephony signals are accessed or received at a remote control device. The Internet Protocol textual/graphical information and/or television signals are displayed on a display of the remote control device, and the Internet Protocol telephony signals are audibly presented at the remote control device. The remote control device may include a keypad for receiving user inputs, thus allowing the user to select a channel or a Uniform Resource Locator (URL) on a remote device, such as a computer, television, set-top box, and/or an embedded set-top box and television. The keypad may also allow the user to receive and place a telephone call using the remote control device. The remote control device may additionally or alternatively present a list of accessible information on the display, allowing the user to scroll the list for telephone numbers, websites, and other content or information. Because the remote control device may display this list of accessible information, the user need not fumble with a cumbersome alphabetical listing of keys when selecting content. Moreover, the list of accessible information may be remotely created (such as from a computer) and downloaded to the remote control device. Here, then, the remote control device is a multi-mode communications device that combines the functionality of a television remote and a telephone, and extends those capabilities to accessing/displaying Internet content, retrieving and presenting graphical information, and multimedia communications such as video chat.

According to other embodiments, an apparatus is also disclosed. This apparatus includes a transceiver and a display. The transceiver receives web content (e.g., HTTP), Internet Protocol television signals, and Internet Protocol telephony signals at a remote control device. The display of the remote control device displays the graphical, textual, or Internet Protocol television signals. Means for audibly presenting the Internet Protocol telephony signals, and other audio signals (such as web radio) are also included.

Other exemplary embodiments include a personal communications and control system. This system comprises a set top box communicating three streams of signals between a remote control device and the set top box. The streams of signals include television signals, telephone signals, and control signals, as well as other video, audio, or graphical content. The remote control device has a display that visually presents the television signals, and the remote control device audibly presents the telephone signals as a telephone call. The remote control device sends the control signal to remotely control a device. The remote control device thus has video capabilities, wireless control capabilities, and wireless communications capabilities.

Still more exemplary embodiments include a set top box routing signals to a remote control device. The set top box comprises a radio interface that wirelessly communicates television signals and telephone signals to the remote control device. The set top box communicates a first channel of the television signals and a second channel of the television signals. The second channel is wirelessly communicated to the remote control device, and the set top box also wirelessly communicates the telephone signals to the remote control device. The remote control device includes a processor, a remote transceiver, a display, and means for switching modes of operation. The remote transceiver receives the second channel and the telephone signals. The processor processes the second channel for the display, and the processor also processes the telephone signals as a telephone call. The remote control device sends a control signal to remotely control the set top box. The means for switching modes of operation allows a user to switch operation of the remote control device between i) a remote mode that controls operation of the set top box, ii) a monitor mode that displays the second channel of the television signals, and iii) a telephone mode that processes the telephone call.

Yet more exemplary embodiments include a method of communicating streams of signals between a remote control device and a set top box. The streams of signals comprise television signals, telephone signals, and control signals, as well as other video, audio, or graphical content. The television signals are displayed at the remote control device, and the telephone signals are presented as a telephone call at the remote control device. The remote control device also sends the control signal to remotely control the set top box.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### DESCRIPTION OF THE DRAWINGS

These and other features, aspects, and advantages of the embodiments of the present invention are better understood when the following Detailed Description is read with reference to the accompanying drawings, wherein:

FIG. 1 is a schematic illustrating the exemplary embodiments;

FIG. 2 is a schematic illustrating another of the exemplary embodiments;

FIG. 3 is a schematic illustrating an exterior view of the remote control device shown in FIGS. 1 and 2;

FIG. 4 is a schematic illustrating a telephony mode of operation, according to the exemplary embodiments; and

FIG. 5 is a block diagram of the remote control device shown in FIGS. 1-4, according to more exemplary embodiments.

### DETAILED DESCRIPTION

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named manufacturer.

The exemplary embodiments describe a remotely-controlled communications and information system. This communications and information system includes a set top box and a multi-function personal communications and control device. The set top box wirelessly communicates television signals, telephony signals, and other data to and from the personal communications and control device. The personal communications and control device includes its own display, thus operating as a monitor for viewing video content. Similarly, the remote device includes the capability to deliver packetized audio content to a local speaker or headphone, permitting monitoring of audio content. The personal communications and control device, however, also includes a microphone, thus operating as a telephone for making and receiving telephone calls. The personal communications and control device can also use its display for text chat sessions and, when a video camera is incorporated, it can support video chat sessions as well. This personal communications and control device may also send and receive command signals, thus remotely controlling operation of a television, audio component, a computer, or other electronic device. A user may thus use the personal communications and control device to remotely command a television and/or computer, to place and to receive telephone calls, text chat sessions and video chat sessions, and to watch the same or a different channel from that shown on a television/computer.

The remote control device may include means for switching modes of operation. The personal communications and control device may operate in multiple modes: as a remote control device controlling operation of an electronic device (such as a television, audio component, computer, or appliance), as a monitor displaying visual content, and a wireless/cordless telephone placing and receiving telephone calls, text chat sessions, and video chat sessions. The personal communications and control device, then, includes means for switching between these modes of operation. The means for switching modes of operation may use signaling, such as SIP signaling, to set up sessions whose content is associated based on packet headers. For example, packets containing SIP messages are exchanged to set up sessions in which SIP-capable end points are able to exchange packets containing encoded voice (e.g., G.711) in a real time protocol (RTP) session. The means for switching modes of operation may additionally or alternatively appropriately switch modes of operation. If signaling and/or a header identifies video content, the packet is visually/audibly presented. If, for example, the personal communications and control device receives packet signaling indicating an incoming telephone call, it transitions into the correct mode to handle the telephone call. The personal communications and control device may also originate signals to the set top box which indicate that it is sending remote control signaling packets, originating a video chat, or requesting specific video (e.g., packet television) or other digital content from local or remote storage.

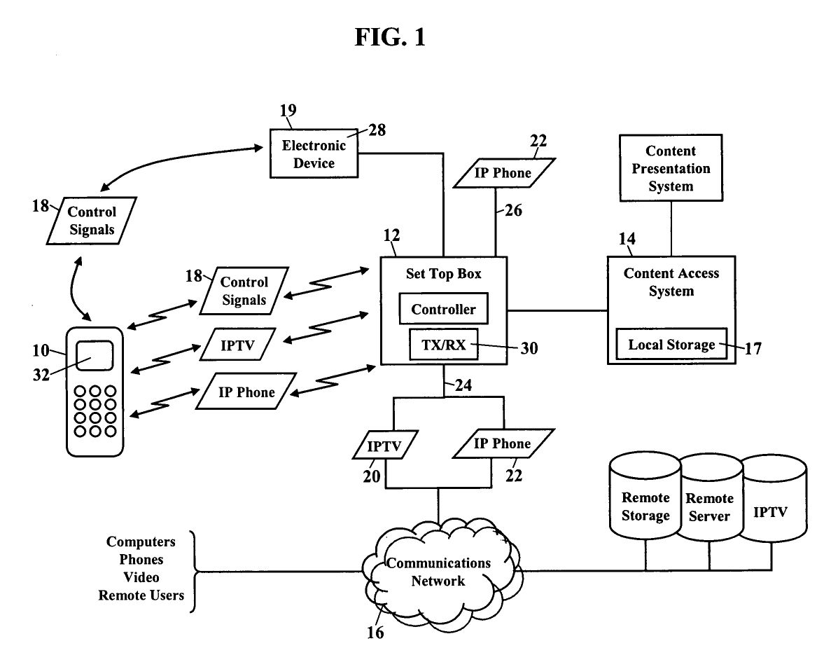

FIG. 1 is a schematic illustrating the exemplary embodiments. FIG. 1 illustrates a personal communications and control system. The personal communications and control system comprises a personal communications and control device 10 and a set top box 12. The set top box 12 communicates with a content access system 14 and with a communications network 16. The content access system 14 may include local content storage 17, such as computer memory, a personal digital recorder, a disk drive, or any other memory storage device. The personal communications and control device 10 can wirelessly access files, movies, and all other types of content from the local content storage 17. The personal communications and control device 10, however, can also wirelessly access all types of content via the communications link between the set top box 12 and the communications network 16. That is, the personal communications and control device 10 can wirelessly access all types of content from both the local content storage 17 and from remote content sources via the communications network 16 (such as via the Internet). The personal communications and control device 10 can also wirelessly send control signals 18 to an electronic device 19. The electronic device 19 may be a television, a computer, a monitor, a digital recorder, an appliance, an audio component, or any other device capable of being remotely controlled. These control signals 18 allow the personal communications and control device 10 to control selection of channel, volume, and other features as will be further explained. The personal communications and control device 10, then, operates a multiple-mode hand held remote control that can access the Internet.

The personal communications and control device 10, however, can also operate as a monitor and as a wireless phone. As FIG. 1 illustrates, the set top box 12 receives Internet Protocol television signals 20 and Internet Protocol telephony signals 22. The Internet Protocol television signals (shown as “IPTV” for simplicity) 16 and the Internet Protocol telephony signals 18 may be packetized according to a packet protocol. While there are many packet protocols, the Internet Protocol (“IP”) is most common, although not required. The Internet Protocol television signals 20 and the Internet Protocol telephony signals 22 may be commonly received via a single broadband connection 24 to the communications network 16. The single broadband connection 24 may be a digital subscriber line (DSL), a coaxial cable, a fiber optic cable, a hybrid coaxial cable, and/or even twisted pair lines. The Internet Protocol television signals 20 may alternatively be received via the single broadband connection 24, while the Internet Protocol telephony signals 22 are received via a separate connection 26 (such as a separate twisted pair, cable, or fiber). The set top box 12 inspects each packet (perhaps using a header portion) and forwards/routes the packet to its intended destination. The Internet Protocol television signals 20, for example, may be routed to the electronic device 19 (perhaps a television) and visually/audibly presented on a display device 28 (such as a cathode ray tube, a liquid crystal display, a plasma display, or other means for display), thus allowing a viewer to watch, hear, other otherwise experience content. The Internet Protocol television signals 20 may additionally or alternatively be routed to the content access system 14 (perhaps a computer), thus also allowing the viewer to experience the content on a monitor (again as a cathode ray tube, a liquid crystal display, a plasma display, or other means for display). The set top box 12 also includes one or more radio interfaces (shown as “TX/RX”) 30 that wirelessly communicate the Internet Protocol television signals 20 and the Internet Protocol telephony signals 22 to the personal communications and control device 10.

The personal communications and control device 10 operates as a multiple-mode communications device. That is, the personal communications and control device 10 may operate as a remote control, as a monitor, and as a personal communications device. The personal communications and control device 10 can remotely control operation of the electronic device 19. The personal communications and control device 10 can operate as an audio and/or video monitor by displaying video or graphical signals or by playing audio files (such as .wav files). The personal communications and control device 10 may also operate as a telephone and/or as a hand-held video chat device. The personal communications and control device 10 is thus a hand-held remote control device that can also receive and present television signals, receive and place telephone calls (or video chat sessions), and access stored content. The personal communications and control device 10 wirelessly receives the Internet Protocol television signals 20 and the Internet Protocol telephony signals 22. The Internet Protocol television signals 20 are visually presented on a display 32 of the personal communications and control device 10, while the Internet Protocol telephony signals 22 are audibly presented at the personal communications and control device 10. A user may thus use the personal communications and control device 10 to place and to receive telephone calls and video chat sessions, and the user may use the personal communications and control device 10 to wirelessly send channel, volume, Uniform Resource Locators, and other control signals 18 to the electronic device 19.

The set top box 12 wirelessly routes packets of data. When the set top box 12 receives the packets of data, the set top box 12 inspects a header portion of each packet. The header portion may include a destination address, thus allowing the set top box 12 to inspect each packet and to determine its destination. Any packets that are to be wirelessly transmitted are sent to the radio interface 30. Any Internet Protocol television signals 20 that are destined for the personal communications and control device 10 are wirelessly transmitted from the set top box 12. Those Internet Protocol telephone signals 22 destined for the personal communications and control device 10 are likewise wirelessly transmitted from the set top box 12. The set top box 12 wirelessly transmits the Internet Protocol television signals 20 and the Internet Protocol telephone signals 22 using any portion of the electromagnetic spectrum and any signaling standard. The radio interface 30, for example, may utilize any of the I.E.E.E. 802 family of standards and/or the various cellular standards (CDMA, TDMA, and/or GSM).

The personal communications and control device 10 receives packets of data from the set top box 12. The set top box 12 wirelessly transmits the Internet Protocol television signals 20 and the Internet Protocol telephone signals 22 to the personal communications and control device 10. The personal communications and control device 10 processes the Internet Protocol television signals 20 for display on the display device 32 (such as a cathode ray tube, a liquid crystal display, a plasma display, or other means for display). That is, the personal communications and control device 10 is capable of audibly and/or visually presenting the Internet Protocol television signals 20 on the display device 32, thus allowing a user to view the wirelessly transmitted television signals. The personal communications and control device 10, however, also processes the Internet Protocol telephone signals 18 as a telephone call, thus allowing the user to place and to receive a telephone call. The personal communications and control device 10 is also capable of sending the control signal 18 to remotely control the electronic device 19. The personal communications and control device 10 may alternatively send the control signal 18 to the set top box 12, and the set top box 12 would route the control signal 18 to its appropriate destination.

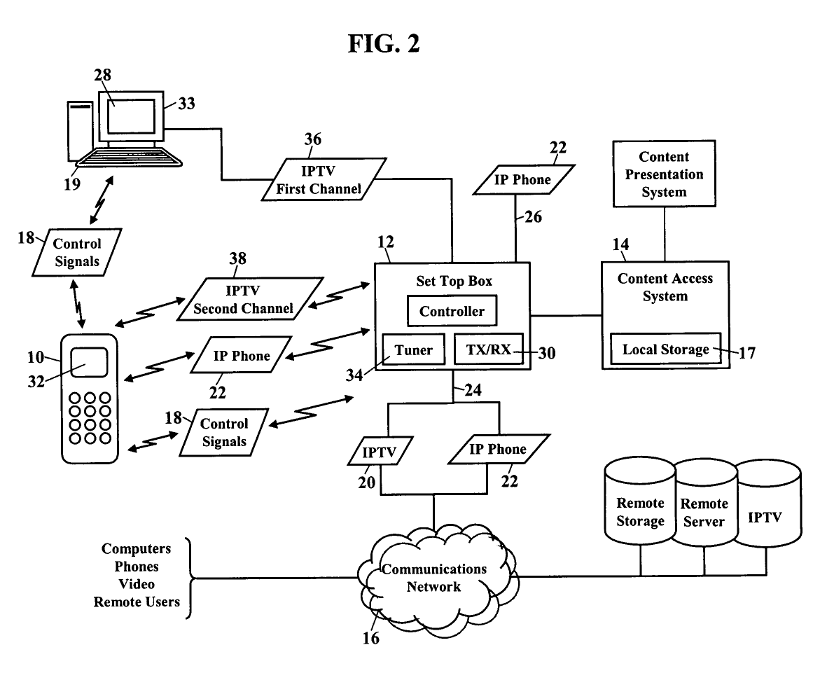

FIG. 2 is a schematic illustrating another personal communications and control system. The personal communications and control system comprises the personal communications and control device 10, the set top box 12, and the electronic device 19. Here the electronic device 10 is shown as a computer 33, yet the electronic device could be a television, another set-top box, a monitor, an appliance, an audio component, and/or home theater component. The set top box may additionally or alternatively be embedded in a television, a computer, or a monitor. The set top box 12 receives the Internet Protocol television signals 20, the Internet Protocol telephone signals 22, and other packets of data. The set top box 12 detects, tunes, and/or isolates a first channel 36 and a second channel 38. The set top box 12 routes the first channel 36 of the Internet Protocol television signals to the computer 32, and the set top box 12 wirelessly routes the second channel 38 of the Internet Protocol television signals to the personal communications and control device 10. The set top box 12 also wirelessly routes the Internet Protocol telephone signals 20 to the personal communications and control device 10. The set top box 12 may include a single tuner, dual tuners, or even more tuners (shown simply as “Tuner” 34) that tune and produce the first channel 36 and the second channel 38.

The personal communications and control device 10 receives the packets of data. The personal communications and control device 10 receives the second channel 38 and the Internet Protocol telephone signals 22. The personal communications and control device 10 processes the second channel 38 for the display 32 and processes the Internet Protocol telephone signals 22 as a telephone call. The first channel 36 of the Internet Protocol television signals routes to the computer 33, while the second channel 38 of the Internet Protocol television signals is received, processed, and displayed by the personal communications and control device 10. The personal communications and control device 10, therefore, can be used to “surf” alternate channels. The personal communications and control device 10 receives a different channel from the computer 33. That is, the computer 33 receives and/or displays the first channel 36, while the remote control device 10 receives and displays the second channel 38. Because the personal communications and control device 10 receives the different, second channel 38, a user can scan alternate channels without disturbing the content (e.g., the first channel 36) presented by the computer 33. Although the one or more tuners 34 are shown as components of the set top box 12, the one or more tuners 34 may be components of the computer 33, a television, a monitor, an appliance, an audio and/or home theater component, or embedded in the design of a television, a computer, or a monitor.

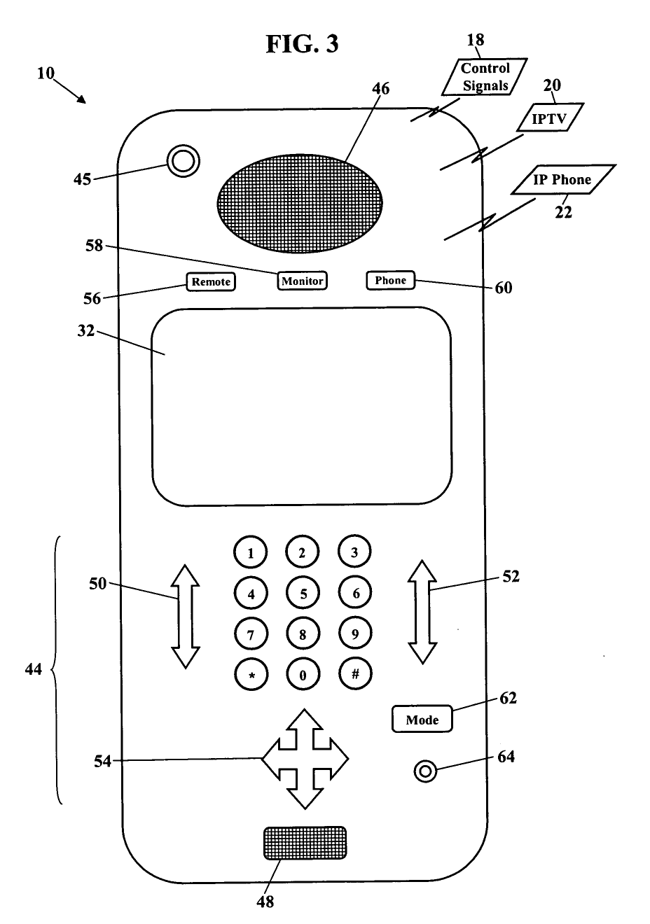

FIG. 3 is a schematic illustrating an exterior view of the personal communications and control device 10 shown in FIGS. 1 and 2. The personal communications and control device 10 includes the display 32, a keypad 44, a speaker 46, and a microphone 48. The display 32 visually presents the Internet Protocol television signals 20 or other stored/web content, thus allowing a user to watch, hear, other otherwise experience content. The display 32 may be a cathode ray tube, a liquid crystal display, a plasma display, or any other means for displaying video and/or graphical content. The keypad 44 may include at least ten (10) buttons (numerically labeled “0” through “9”) and may also include buttons labeled “*” and “#.” The keypad 44 may also include buttons with alphabetical designations, and/or the keypad 44 could include function buttons that permit a single button to represent one or more alphanumeric characters. The keypad 44 may also include a set 50 of channel buttons and a set 52 of volume buttons. The set 50 of channel buttons allows the user to advance or decrement a channel selection, while the set 52 of volume buttons allows the user to increase/decrease volume. A set 54 of scroll buttons allows the user to scroll in an up, down, left, and right direction along the display 32. A joystick could, instead, allow the user to enter scrolling movements. The keypad 44 may also include any number of auxiliary buttons, such as a “last channel” command, a “favorite channel” command, a “guide” or “schedule” button for viewing a programming schedule, and a “yellow pages” button (perhaps having a yellow color) for commanding receipt of a Yellow Pages channel. The keypad 44 may additionally or alternatively include other buttons with various functions and/or commands, and the personal communications and control device 10 may be programmed to recognize commands having sequences of buttons.

The personal communications and control device 10 has multiple modes of operation. The personal communications and control device 10 can operate as a remote control, a monitor, or a telephone. The personal communications and control device 10 can wirelessly send and/or receive the control signals 18, thus controlling operation of the electronic device (shown as reference numeral 19 in FIGS. 1 and 2). The personal communications and control device 10 can also wirelessly receive, and visually present, the Internet Protocol television signals 20. The personal communications and control device 10 can also wirelessly receive and audibly present the Internet Protocol telephony signals 22. The personal communications and control device 10 may access a suitably formatted IP telephony display/portal providing information about incoming calls, call handling controls, and/or call logs. The personal communications and control device 10 may also include a digital camera (e.g., FIG. 3 shows a digital camera lens 45), thus permitting video chat sessions, still photos, and video recording. A user may thus use the remote control device 10 to send control signals, to view the Internet Protocol television signals 20 and other web content, and to place and to receive telephone calls.

The personal communications and control device 10 may include means for switching modes of operation. The personal communications and control device 10 may operate in any of multiple modes: a remote controlling operation of the electronic device (shown as reference numeral 19 in FIG. 1), a monitor displaying television signals, and a wireless/cordless telephone (such as Wi-Fi enabled) placing and receiving telephone calls. The personal communications and control device 10, then, includes means for switching between these modes of operation. The personal communications and control device 10, for example, may include one or more mode buttons that switch modal operation. Three separate mode buttons, for example, would allow the user to select multiple modes of operation. A first button 56, when depressed, would set the personal communications and control device 10 in the remote mode of operation. A second button 58 would select monitor operation, while a third button 60 would select telephone operation. A single function button 62, alternatively, would selectively switch modal operation. A first depression of the single function button 62 would select the remote mode of operation, while a second and third depression would successively select the monitor and the telephone operation. The means for switching modes of operation could additionally or alternatively include a multiple-position slide switch, with each position corresponding to a mode of operation. The means for switching modes of operation could additionally or alternatively include a processor executing instructions that allows the user to scroll along the display 32 and to select modal operation. The means for switching modes of operation could additionally or alternatively include one or more indicators of modal operation. The display 32, for example, could visually present the current mode. The speaker 46 could audibly emit the current mode. One or more lights (such as a light emitting diode or a backlit button) could visually indicate the current mode. The means for switching modes of operation could additionally or alternatively include a joystick or navigation key selection from graphical user interface (GUI) menus displayed on the device. The joystick and/or the GUI menus would minimize the number of confusing buttons.

The means for switching modes of operation may utilize packet headers. Packetizing schemes form packets of information. Each packet has a header portion and a payload portion. The personal communications and control device 10 may receive packets of data from a set top box that routes packets of data to the proper destination. The personal communications and control device 10 inspects the header portion of each packet. That is, when a packet is received, the personal communications and control device 10 inspects the header to determine how the packet is processed. If the header identifies the packet as containing video content, the packet is visually/audibly presented. The packet may be recognized as containing signaling information indicating a request to accept an incoming voice over Internet Protocol telephone call, a request for a video chat session, a response to a browser request for web content, or other such requests. Packet protocols and signaling information are known in the art and will not be further discussed. If the header identifies the packet as containing telephony signals, the packet is processed as a telephone call. Likewise, the personal communications and control device 10 may packetize data for transmission. Telephone calls and/or command signals may be packetized with a header portion. The header portion identifies how the packet should be processed by the receiving device.

When the personal communications and control device 10 operates in the remote mode, the remote wirelessly communicates control signals. The user can depress buttons on the keypad 44 and control operation of the electronic device (shown as reference numeral 19 in FIG. 1). The electronic device, as earlier described, could be a television, an embedded digital television, a computer, an audio component, the set top box (shown as reference numeral 12 in FIG. 1), or other electronic device. The personal communications and control device 10 can send commands, for example, that change channels, change volume, and select movies, audio, games, or other content. The personal communications and control device 10 could select and/or control operation of a radio, an audio receiver, a personal video recorder, a DVD/CDROM device, an .mp3 device, or any other electronic device. The remote mode of operation is know in the art and will not be further described.

When the personal communications and control device 10 operates in the monitor mode, the user can view streams of data. The personal communications and control device 10, for example, can wirelessly receive, and visually present, the Internet Protocol television signals 20. The user may thus watch television signals via the display 32. When the means for switching modes of operation selects the monitor mode, the keypad 44 can be used to select what channel is received by the personal communications and control device 10. The personal communications and control device 10, for example, may receive the same channel as a television being remotely controlled. The user of the personal communications and control device 10 could depress the set 52 of volume buttons to adjust the volume of the speaker 46. Because the personal communications and control device 10 can receive the same channel as a television, the personal communications and control device 10 could be a portable monitor, thus allowing supervision of what is watched on the television.

The personal communications and control device 10, however, could be used to “surf” alternate channels or alternate/web content. In fact, channel selection could be made via an IPTV web portal which presents a “clickable” list of available IPTV content. The personal communications and control device 10 may receive a different channel from the television being remotely controlled. That is, the television displays one channel, while the personal communications and control device 10 receives and displays a second channel. Because the personal communications and control device 10 may receive a different channel, a user could scan alternate channels without disturbing those people watching the television. The user of the personal communications and control device 10 could depress the set 50 of channel buttons to advance or decrement channel selection. The user of the personal communications and control device 10 could also enter a channel using the keypad 44. The user may use the set 52 of volume buttons to adjust the volume of the speaker 46. The user may even insert a male headphone jack into a female jack 64, thus allowing the user to privately listen to an alternate channel or to alternate content. The personal communications and control device 10 may alternatively or additionally wirelessly communicate (e.g., any of the I.E.E.E. 802 standards, such as “Bluetooth”) with a headset when to privately listening to an alternate channel or to alternate content.

The personal communications and control device 10 could also receive alternate content. Because the personal communications and control device 10 wirelessly receives the Internet Protocol television signals 20, those signals 20 could represent alternate content. The Internet Protocol television signals 20, for example, could represent a second stream of audible and/or visual content from the content access system or from the communications network (shown, respectively, as reference numerals 14 and 16 in FIG. 1). The personal communications and control device 10, for example, could also receive alternate content from a DVD or CDROM player, hard disk, memory, personal video recorder, video player/camera, .mp3/4 device, computer, or any other electronic device. The personal communications and control device 10 could also receive alternate content via the communications network 16, such as from a remote storage device, a remote server, website, or other location.

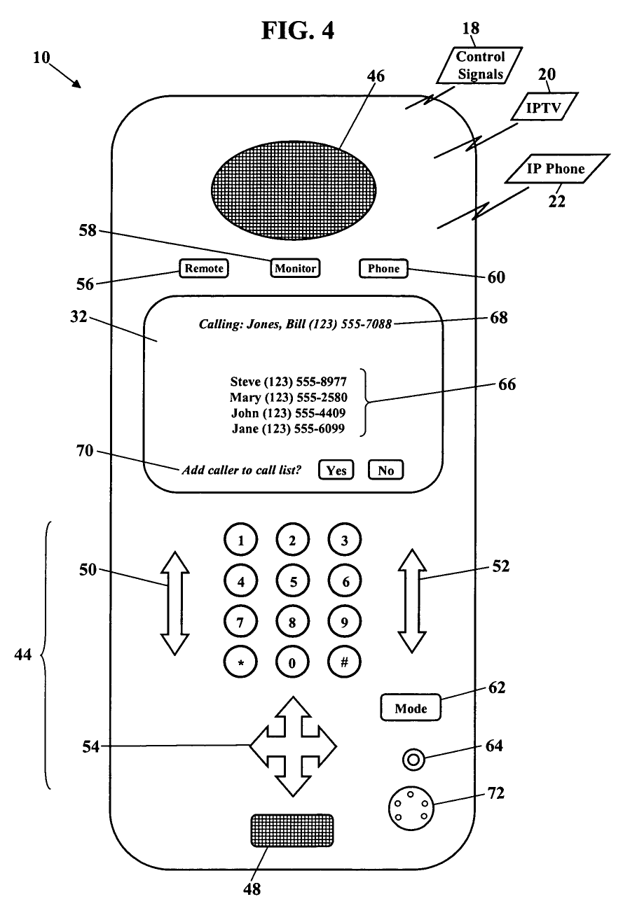

FIG. 4 is a schematic illustrating a telephony mode of operation, according to the exemplary embodiments. The personal communications and control device 10 may wirelessly receive the Internet Protocol telephony signals 22. The user may thus receive telephone calls using the personal communications and control device 10. When the means for switching modes of operation is in the telephone mode, the personal communications and control device 10 can also send signals to establish a telephone call. The user speaks into the microphone 48 and listens at the speaker 46. The personal communications and control device 10, then, is preferably ergonomically sized and configured for telephone usage. The user can enter a telephone number using the keypad 44, and the dialed number is visually presented on the display 32. A sequence of one or more keys may be recognized that causes a call list 66 to be displayed on the display 32. The call list 66 could contain recently received calls, recently placed/dialed calls, missed calls, and/or frequently called numbers. The call list 66 may additionally or alternatively contain an alphabetical listing of contacts and their stored telephone numbers. The set 54 of scroll buttons, or some other sequence of keys, allows the user to scroll up, down, left, and/or right along the call list 66. The keypad 44 may even permit the user to highlight an entry in the call list 66 and place a call to that number.

Because the personal communications and control device 10 has multiple modes of operation, the personal communications and control device 10 can have many advantageous features. When, for example, a telephone call is received, the remote can automatically display caller identification information 68 on the display 32. Even though the personal communications and control device 10 may be operating in the monitor mode (and thus receiving the Internet Protocol television signals 20 or other content), the caller identification information 68 would be displayed on the display 32. The user could immediately know the calling name and/or number of the calling party, even though the user is watching/listening/experiencing a content stream. When the call is received, the personal communications and control device 10 may produce an audible alert (such as a ring or buzz) from the speaker 46. That is, when the telephone call is received, processing of audio content is halted and, instead, the audible alert is produced. The user may then switch the personal communications and control device 10 to the telephony mode and accept the call. The personal communications and control device 10 could alternatively automatically switch to the telephony mode when the telephone call is received. Because the calling telephone name and number is displayed on the display 32, an option 70 could be displayed that automatically adds the caller identification information to the call list 66. Other options could be displayed that send the telephone call to voicemail, that answer the call, that forward the call to another number of another destination, or that reject the call.

The personal communications and control device 10 could also receive other communications. Although the personal communications and control device 10 can place and receive telephone calls, the device 10 may also send and receive other electronic communications. The personal communications and control device 10, for example, may receive emails, faxes, pages, instant messages, and other electronic communications. When an email is received, the sender's email address or other identifier can be visually presented on the display 32. The user of the personal communications and control device 10 could open the email and read the body text. If the user wishes to respond to the email, the user may use the keypad 44 to compose a response. The user could alternatively insert a keyboard plug into a port 72 and type a response using an auxiliary keyboard. The personal communications and control device 10 could similarly present a sender's communications address for pages, faxes, instant messages, and any other electronic communication, and the user can respond to these communications using the keypad 44 or the auxiliary keyboard.

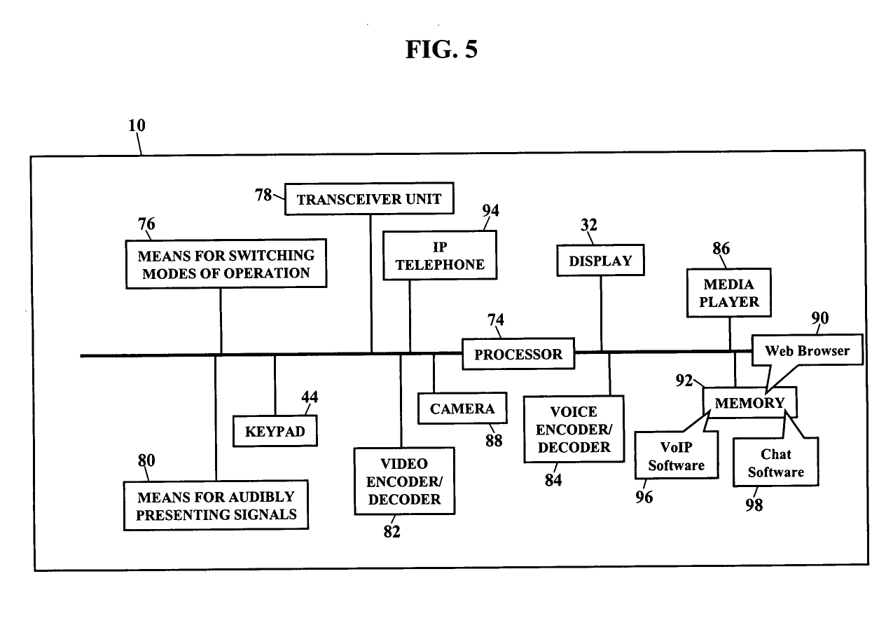

FIG. 5 is a block diagram of the personal communications and control device 10 shown in FIGS. 1-4, according to the exemplary embodiments. The personal communications and control device 10 includes a processor 74 interfacing with the display 32 and the keypad 44. The processor 74 also interfaces with the means 76 for switching modes of operation between the remote mode, the monitor mode, and the telephone mode. A transceiver unit 78 interfaces with the processor 74 and receives the Internet Protocol television signals and the Internet Protocol telephony signals (shown, respectively, as reference numerals 20 and 22 in FIGS. 1-4). The transceiver unit 78 may also wirelessly send the control signals (shown as reference numeral 18 in FIGS. 1-3). The personal communications and control device 10 includes means 80 for audibly presenting the Internet Protocol television signals and/or the Internet Protocol telephony signals. The means 80 for audibly presenting the signals may include the speaker (shown as reference numeral 46 in FIGS. 3 and 4), a piezoelectric element, and/or any other device that emits sounds. The personal communications and control device 10 may also include a video decoder 82 for decoding video signals, an encoder/decoder 84 for encoding and/or decoding signals, and a media player 86 for executing media files. The personal communications and control device 10 may include camera circuitry 88 for capturing digital images and video. A web browser 90 may be stored in memory 92, and the web browser allows navigation of local and remote destinations. The personal communications and control device 10 may also include an Internet Protocol telephony unit 94 and Voice over Internet Protocol (VoIP) client software 96 for processing of the Internet Protocol telephony signals. The Internet Protocol telephony unit 94 and/or the Voice over Internet Protocol (VoIP) client software 96 handles telephony signaling (e.g., for incoming call handling or call origination) and decodes digitally encoded voice. Chat software 98 enables and controls text chat sessions and/or video chat sessions. When the chat software 98 enables and controls a video chat session, the chat software 98 interfaces with the camera circuitry 88. The memory 92 may also store Uniform Resource Locators, call logs, call lists, personal information, and other data. The personal communications and control device 10 may send and receive signals using any portion of the electromagnetic spectrum and any signaling standard. The transceiver unit 78, for example, may utilize the various cellular standards (CDMA, TDMA, and/or GSM) and/or any of the I.E.E.E. 802 family of standards.

The processor 74 may be implemented with a digital signal processor (DSP) and/or a microprocessor. Advanced Micro Devices, Inc., for example, manufactures a full line of microprocessors (Advanced Micro Devices, Inc., One AMD Place, P.O. Box 3453, Sunnyvale, Calif. 94088-3453, 408.732.2400, 800.538.8450, www.amd.com). The Intel Corporation also manufactures a family of microprocessors (Intel Corporation, 2200 Mission College Blvd., Santa Clara, Calif. 95052-8119, 408.765.8080, www.intel.com). Other manufacturers also offer microprocessors. Such other manufacturers include Motorola, Inc. (1303 East Algonquin Road, P.O. Box A3309 Schaumburg, Ill. 60196, www.Motorola.com), International Business Machines Corp. (New Orchard Road, Armonk, N.Y. 10504, (914) 499-1900, www.ibm.com), and Transmeta Corp. (3940 Freedom Circle, Santa Clara, Calif. 95054, www.transmeta.com). Texas Instruments offers a wide variety of digital signal processors (Texas Instruments, Incorporated, P.O. Box 660199, Dallas, Tex. 75266-0199, Phone: 972-995-2011, www.ti.com) as well as Motorola (Motorola, Incorporated, 1303 E. Algonquin Road, Schaumburg, Ill. 60196, Phone 847-576-5000, www.motorola.com). There are, in fact, many manufacturers and designers of digital signal processors, microprocessors, controllers, and other componentry that are described in this patent. Those of ordinary skill in the art understand that this componentry may be implemented using any suitable design, architecture, and manufacture. Those of ordinary skill in the art, then understand that this invention is not limited to any particular manufacturer's component, nor architecture, nor manufacture.

While exemplary embodiments of the present invention have been described with respect to various features, aspects, and embodiments, those skilled and unskilled in the art will recognize the invention is not so limited. Other variations, modifications, and alternative embodiments may be made without departing from the spirit and scope of the present invention.

What is claimed is:

1. A system, comprising:
a set top box communicating three streams of signals between a remote control device and the set top box, the streams of signals comprising television signals, telephone signals, and control signals;
the remote control device comprising a display that visually presents the television signals;
the remote control device presenting the telephone signals as a telephone call; and
the remote control device sending the control signal to remotely control a device.

2. A system according to claim 1, wherein the remote control device further comprises a camera and software stored in memory enabling chat sessions.

3. A system according to claim 1, wherein the remote control device further comprises browser software stored in memory enabling access to remotely stored resources.

4. A system according to claim 1, wherein the remote control device displays caller identification information on the display, the caller identification information corresponding to the telephone signals.

5. A system according to claim 1, further comprising means for switching modes of operation between i) a remote mode that controls operation of the another device, ii) a monitor mode that displays the television signals, and iii) a telephone mode that receives the telephone signals.

6. A system according to claim 5, wherein means for switching modes of operation at least one of i) automatically switches from the monitor mode to the telephone mode when the telephone signals are received and ii) automatically switches from the remote mode to the telephone mode when the telephone signals are received.

7. A system according to claim 5, further comprising a processor interfacing with the means for switching modes of operation between the remote mode, the monitor mode, and the telephone mode.

8. A system according to claim 1, wherein the remote control device displays a first channel of the television signals, and wherein the remote control device sends the control signal to control selection of another channel of the television signals.

9. A system according to claim 1, wherein the remote control device displays a first channel of the television signals, and wherein the remote control device sends the control signal to control selection of another channel of the television signals processed by the set top box.

10. A system, comprising:
a set top box routing signals to a remote control device;
the set top box comprising a radio interface that wirelessly communicates television signals and telephone signals to the remote control device, the set top box communicating a first channel of the television signals and a second channel of the television signals, the second channel wirelessly communicated to the remote control device, and the set top box also wirelessly communicating the telephone signals to the remote control device;
the remote control device comprising a processor, a remote transceiver, a display, and means for switching modes of operation, the remote transceiver receiving the second channel and the telephone signals, the processor processing the second channel for the display, the processor also processing the telephone signals as a telephone call, the remote control device sending a control signal to remotely control the set top box, and the means for switching modes of operation allowing a user to switch operation of the remote control device between i) a remote mode that controls operation of the set top box, ii) a monitor mode that displays the second channel of the television signals, and iii) a telephone mode that processes the telephone call.

11. A system according to claim 10, wherein the remote control device further comprises a camera and software stored in memory enabling chat sessions.

12. A system according to claim 10, wherein the remote control device further comprises browser software stored in memory enabling access to remotely stored resources.

13. A system according to claim 10, wherein the remote control device displays caller identification information on the display, the caller identification information corresponding to the telephone call.

14. A system according to claim 10, wherein means for switching modes of operation at least one of i) automatically switches from the monitor mode to the telephone mode when the telephone signals are received and ii) automatically switches from the remote mode to the telephone mode when the telephone signals are received.

15. A method, comprising:
communicating three streams of signals between a remote control device and a set top box, the streams of signals comprising television signals, telephone signals, and control signals;
displaying the television signals at the remote control device;
presenting the telephone signals as a telephone call at the remote control device; and
sending the control signal to remotely control the set top box.

16. A method according to claim 15, further comprising enabling access to remotely stored resources via browser software stored in memory.

17. A method according to claim 15, further comprising displaying caller identification information on a display, the caller identification information corresponding to the telephone signals.

18. A method according to claim 15, further comprising switching modes of operation between i) a remote mode that wirelessly communicates control signals, ii) a monitor mode that displays the television signals, and iii) a telephone mode that receives the telephone signals.

19. A method according to claim 18, further comprising at least one of i) automatically switching from the monitor mode to the telephone mode when the telephone signals are received and ii) automatically switching from the remote mode to the telephone mode when the telephone signals are received.

20. A method according to claim 15, further comprising displaying a first channel of the television signals at the remote control device, and sending the control signal to control selection of another channel of the television signals.
